(19) United States
(12) Patent Application Publication
(10) Pub. No.: US 2026/0119185 A1
(43) Pub. Date: Apr. 30, 2026

(54) Dynamic Switching of Keyboard Scan Codes

(71) Applicant: Dell Products L.P., Round Rock, TX (US)

(72) Inventors: Kearson M. Mcnulty, Austin, TX (US); Walter Kemp, Georgetown, TX (US); Suraj M Varma, Portland, OR (US)

(73) Assignee: Dell Products L.P., Round Rock, TX (US)

(21) Appl. No.: 18/932,465

(22) Filed: Oct. 30, 2024

(51) Int. Cl. G06F 9/4401

(52) U.S. Cl. CPC G06F 9/4401

(57) ABSTRACT

A method and apparatus for dynamic switching of keyboard scan codes in an Information Handling System (IHS) is disclosed. The system includes an embedded controller (EC) interfacing with a BIOS to manage scan codes, a bootloader for setting keycodes based on boot menu items, and an operating system agent for adjusting scan codes according to the OS context. The method allows for manual and automatic remapping of keys, ensuring compatibility across different operating systems and enhancing user control over keyboard functionality. This approach addresses mismatched OS and keyboard layouts, improving productivity and user satisfaction.

### BACKGROUND

An Information Handling System (IHS) generally processes, compiles, stores, and/or communicates information or data for business, personal, or other purposes, which allows users to take advantage of that information. Technology and information handling needs and requirements vary between different users and applications. Information handling systems may also vary with respect to what information is handled, how the information is handled, how much information is processed, stored, or communicated, and how quickly and efficiently the information may be processed, stored, or communicated. Variations in information handling systems may be configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems use keyboards to obtain user input. When a user presses a key on the keyboard, an electrical connection is made at the key location. This electrical connection creates a digital signal that is provided to a keyboard controller in the information handling system to indicate that the particular key location has been pressed by the user. Information handling systems come in a variety of form factors, including desktop form factors that are adapted for workstations and portable form factors that are adapted for mobile use. The information handling system's form factor may affect the associated keyboard, such as the number and arrangement of keys on the keyboard. Different information handling systems often run various operating systems. The type of operating system may determine how keys on the information handling system's keyboard are interpreted.

### SUMMARY

According to one aspect, an Information Handling System (IHS) comprises at least one processor configured to execute an operating system (OS), an embedded controller (EC) configured to interface with a basic input/output system (BIOS) to manage keyboard scan codes, and a bootloader configured to read properties of a boot menu item associated with keyboard scan codes, determine if the menu item is set to a default keyboard scan code value, and set hardware values with user-selected keyboard scan codes if the menu item is not set to a default value, wherein the operating system is configured to boot the IHS with the user-selected scan codes.

The IHS may further comprise a bootloader further configured to provide a boot menu to a user, the boot menu comprising one or more items associated with the keyboard scan codes. The bootloader is further configured to receive user-selected keyboard scan codes via the boot menu.

The user-selected keyboard scan codes are configured to remap keyboard keys. The operating system may be a Linux operating system, and the user-selected keyboard scan codes are configured to remap a Windows Copilot key scan code to a right Control key scan code.

The IHS further comprises a keyboard, wherein a Windows Copilot key is activated on the keyboard, and the operating system is configured to receive a scan code for a right Control key.

According to yet another aspect, a method for dynamic switching of keyboard scan codes comprises loading default basic input/output system (BIOS) keyboard scan codes on an Information Handling System (IHS), loading an operating system on the IHS, loading a detection agent on the IHS, automatically detecting, by the detection agent, a type of operating system loaded, automatically detecting, by the detection agent, a type of keyboard attached to the IHS, determining, by the detection agent, whether the keyboard type matches the operating system type, and if the keyboard type matches the operating system type, then completing an IHS boot process, or if the keyboard type does not match the operating system type, then updating a default keyboard scan code.

The updated default keyboard scan code is selected to match a key on a keyboard with the operating system.

A keyboard is coupled to the IHS, the keyboard comprising a plurality of keys, and a selected key is associated with a function that is not available on the operating system, and the updated default keyboard scan code is configured to remap the selected key to a function that is available on the operating system.

The method further comprises enabling a selected keyboard key in a BIOS scan codes package if the selected key is associated with the operating system, and disabling the selected keyboard key in the BIOS scan codes package if the selected key is not associated with the operating system.

The method further comprises updating BIOS scan codes.

The method further comprises updating BIOS default scan codes to match the operating system.

The type of keyboard detected comprises one or more keys associated with functions that are not available from the type of operating system detected, and the updated default keyboard scan code is configured to remap the one or more keys to functions that are available from the type of operating system detected. The one or more keys are selected from the group consisting of: a Windows key, a Copilot key, a Super key, a Menu key, a Command key, and an Option key.

According to yet another aspect, the one or more keys are selected from the group consisting of a Windows key and a Copilot key, wherein the type of operating system is detected to be a Linux operating system, and the updated default keyboard scan code is configured to remap the Windows key to a function available on the Linux operating system and to remap the Copilot key to a right Control key.

A method for manual switching of keyboard scan codes comprises loading default BIOS keyboard scan codes on an Information Handling System (IHS), loading an operating system on the IHS, loading a keyboard agent on the IHS, providing a user interface to allow a user to select default BIOS keyboard scan codes to modify, and updating the default BIOS keyboard scan codes based on a user input.

The method further comprises performing a secure update to the BIOS scan codes.

According to another aspect, the updating the BIOS default keyboard scan codes is configured to ensure persistence of a user-selected BIOS keyboard scan codes across system restarts.

According to yet another aspect, the user interface provides options to disable specific keys that are not required by the operating system.

According to another aspect, the secure update to the BIOS scan codes includes verifying the integrity of the update process to prevent unauthorized modifications.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating an embodiment of an Information Handling System for use with audio spatial panning.

FIG. 2 illustrates an example embodiment of a workstation that may be used for dynamic switching of keyboard scan codes.

FIG. 3 is an example of an older Windows operating system keyboard layout for use with embodiments herein.

FIG. 4 is an example of a newer Windows operating system keyboard layout for use with embodiments herein.

FIG. 5 is an example of a Linux operating system keyboard layout for use with embodiments herein.

FIG. 6 is an example of a macOS operating system keyboard layout for use with embodiments herein.

FIG. 7 is a flowchart illustrating an example process for dynamic switching of keyboard scan codes based on bootloader configuration.

FIG. 8 is a flowchart illustrating an alternative process for dynamic switching of keyboard scan codes based on operating system context.

FIG. 9 is a flowchart illustrating a process for manual switching of keyboard scan codes.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

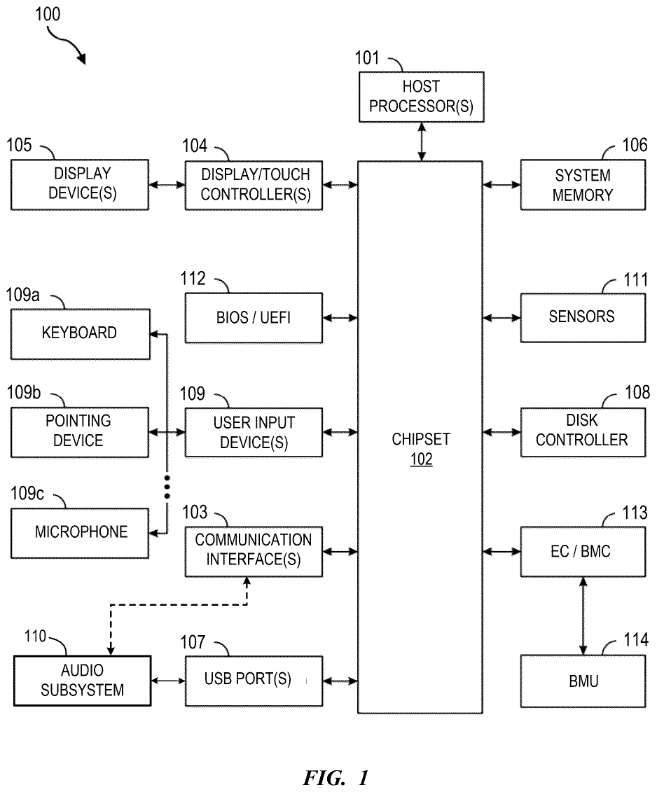

FIG. 1 is a block diagram illustrating an embodiment of an IHS 100. As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to resources. In some cases, chipset 102 may utilize a QuickPath Interconnect (QPI) bus to communicate with host processor(s) 101. Chipset 102 may also be coupled to communication interface(s) 103 to enable communications between IHS 100 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 103 may be used to communicate with peripheral devices (e.g., Bluetooth speakers, microphones, headsets, etc.). Moreover, communication interface(s) 103 may be coupled to chipset 102 via a Peripheral Component Interconnect Express (PCIe) bus, or the like.

Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 provide video or display signals to one or more display device(s) 105. Display device(s) 105 may include Liquid Crystal Display (LCD), Light Emitting Diode (LED), Organic LED (OLED), or other thin film display technologies. Display device(s) 105 may include a plurality of pixels arranged in a matrix, configured to display visual information, such as text, two-dimensional images, video, three-dimensional images, etc. In some cases, display device(s) 105 may be provided as a single continuous display, rather than two discrete displays.

Chipset 102 may provide host processor(s) 101 and/or display controller(s) 104 with access to system memory 106. In various embodiments, system memory 106 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more Universal Serial Bus (USB) ports/controllers 107, to which one or more peripheral devices may be coupled (e.g., integrated or external webcams, microphones, speakers, etc.).

Chipset 102 may further provide host processor(s) 101 with access to a disk controller 108, which may include a disk interface that connects the disc controller 108 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 100. An example of external interface includes a USB interface, an IEEE 1394 (Firewire) interface, a proprietary interface, or a combination thereof.

Chipset 102 may also provide access to one or more user input devices 109, for example, using a super I/O controller or the like. Examples of user input devices 109 include, but are not limited to, a keyboard 109a, pointing device 109b, such as a mouse, trackball, stylus, or active pen, and/or microphone(s) 109c. Other user input devices 109 (not shown) may include a camera, touchpad, totem, etc. Each user input device 109 may include a respective controller (e.g., a touchpad may have its own touchpad controller) that interfaces with chipset 102 through a wired or wireless connection, for example via communication interfaces(s) 103 and/or USB port(s) 107. Other input devices, such as keyboard 109a, may use a keyboard controller in an operating system.

In some cases, chipset 102 may also provide access to one or more output devices, such as an audio subsystem 110, speakers, headsets, video projectors, paper printers, 3D printers, Virtual/Augmented Reality (VR/AR) devices, etc. The output devices may be accessed, for example, via communication interfaces(s) 103 and/or USB port(s) 107. Audio subsystem 110 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 102 may further provide an interface for communications with one or more hardware sensors 111. Sensors 111 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 112 is coupled to chipset 102. UEFI was designed as a successor to BIOS, and many modern IHSs utilize UEFI in addition to or instead of a BIOS. Accordingly, BIOS/UEFI 112 is intended to also encompass a UEFI component. BIOS/UEFI 112 provides an abstraction layer that allows the OS to interface with certain hardware components that are utilized by IHS 100. Upon booting of IHS 100, host processor(s) 101 may utilize program instructions of BIOS 112 to initialize and test hardware components coupled to IHS 100, and to load a host OS for use by IHS 100. Via the hardware abstraction layer provided by BIOS/UEFI 112, software stored in system memory 106 and executed by host processor(s) 101 can interface with I/O devices coupled to IHS 100.

An Embedded Controller (EC) 113 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 100, EC 113 may be made operational from the very start of each power reset, before other devices are fully running or powered on. As such, EC 113 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 113 may be used to manage other core operations of IHS 100 (e.g., turbo modes, maximum operating clock frequencies of certain components, etc.).

In some cases, EC 113 may implement operations for detecting certain changes to the physical configuration or posture of IHS 100 and managing other devices in different configurations of IHS 100. For instance, when IHS 100 as a 2-in-1 laptop/tablet form factor, EC 113 may receive inputs from a lid position or hinge angle sensor 111, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

In some implementations, EC 113 may be installed as a Trusted Execution Environment (TEE) component to the motherboard of IHS 100. Additionally, or alternatively, EC 113 may be further configured to calculate hashes or signatures that uniquely identify individual components of IHS 100. In such scenarios, EC 113 may calculate a hash value based on the configuration of a hardware and/or software component coupled to IHS 100. For instance, EC 113 may calculate a hash value based on all firmware and other code or settings stored in an onboard memory of a hardware component.

In addition, EC 113 may provide an Out-of-Band communication channel that allows an Information Technology Decision Maker (ITDM) or Original Equipment Manufacturer (OEM) to manage IHS 100's various settings and configurations, for example, by issuing OOB commands.

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 114 may be coupled to EC 113 and it may include, for example, an Analog Front End (AFE), storage (e.g., non-volatile memory), and a microcontroller. In some cases, BMU 114 may be configured to collect and store information, and to provide that information to other IHS components.

Examples of information collectible by BMU 114 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 100 may not include all the components shown in FIG. 1. Furthermore, some components that are represented as separate components in FIG. 1 may instead be integrated with other components, such that all or a portion of the operations executed by the illustrated components may instead be executed by the integrated component. For example, in various embodiments described herein, host processor(s) 101 and/or other components shown in FIG. 1 (e.g., chipset 102, display controller(s) 104, communication interface(s) 103, EC 113, etc.) may be replaced by other devices. As such, IHS 100 may assume different form factors including, but not limited to: servers, workstations, desktops, laptops, appliances, video game consoles, tablet computers, smartphones, etc.

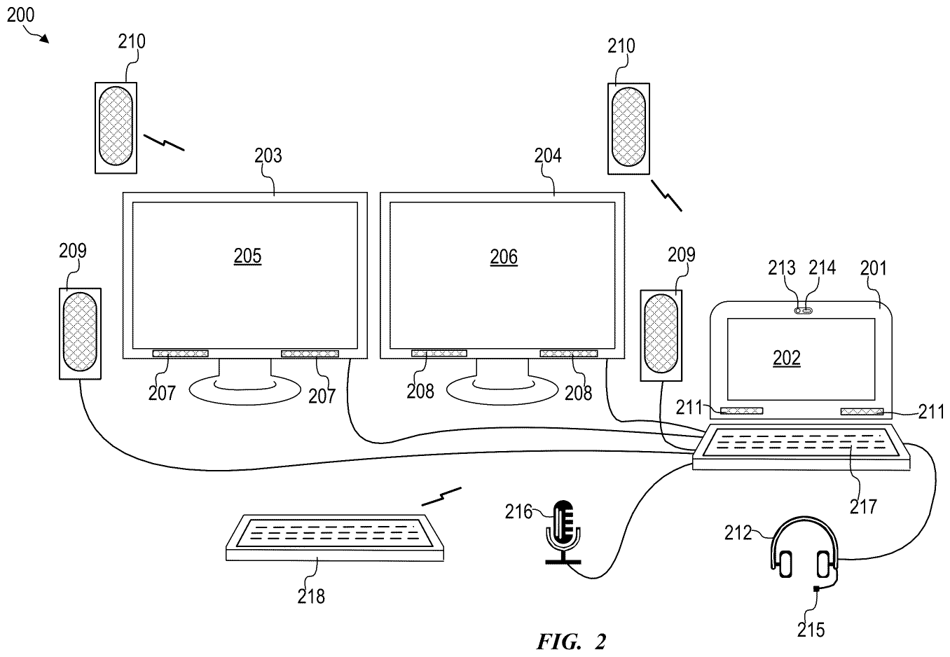

FIG. 2 illustrates an example embodiment of a workstation 200. An IHS 201, such as a laptop computer, has an architecture such as the embodiment shown in FIG. 1. IHS 201 may alternatively be a desktop computer, tablet computer, game console, or other device that supports multiple monitors. In the illustrated embodiment, laptop IHS 201 has a display screen 202 that is used to display applications and other content. IHS 201 is coupled to external monitors 203, 204 having displays 205, 206, respectively. User interfaces and other visual content generated by applications running on IHS 201 may also be displayed on either or both external monitors 203, 204. Each monitor 203, 204 may have one or more speakers 207, 208, respectively. The monitors 203, 204 are connected to IHS 201 via a wired or wireless connection (e.g., HDMI cable, audio cable, Bluetooth connection, etc.) that allows audio content from applications running on IHS 201 to be played over speakers 203 and/or 204.

IHS 201 is also connected to a first pair of external speakers 209 and a second pair of external speakers 210. Speakers 209, 210 may be connected to IHS 201 a wired or wireless connection (e.g., audio cable, Bluetooth connection, etc.). Additionally, IHS 201 may have internal speakers 211. Other devices, such as headphone earphones 212 maybe connected to IHS 201 via a wired or wireless connection. Other types of audio playback devices, such as internal speakers, external speakers, soundbars, subwoofers, center-channel speakers, passive speakers, and active speakers may be connected to IHS 201.

Devices, such as IHS 201, using existing Operating Systems (OS), such as Windows 10, macOS, or Linux OS, determine which speakers to use based on a selected audio output device configuration. This may include a default output device wherein the OS assigns a default audio output device, such as built-in speakers, external speakers, headphones, Bluetooth devices, etc.), on which sounds are played. A user may manually select the preferred audio device in the OS sound settings. In some cases, built-in detection systems either in IHS hardware or the OS may prioritize external audio devices, such as speakers using an audio jack or a Bluetooth/USB connection. Audio drivers, such as software that interfaces between the OS and audio hardware, may also manage which speakers are used.

IHS 201 may also be connected to one or more audio input devices, such as build-in and external microphones. IHS 201 may include an internal camera 213 and microphone 214 that allows the user to participate in video conferences or other communication sessions. In other configurations, an external camera with integrated microphone may be connected to IHS 201. Headset 212 may also include a microphone 215 that allows the user to communicate during a call or while gaming using headset 212. Alternatively, IHS 201 may be connected to a stand-alone external microphone 216, which may be a condenser, dynamic, or ribbon microphone depending upon the user's preference and the task requiring a microphone, such as public speaking and performances or studio recording of vocals and instruments. The external microphone 216 may be connected to IHS 201 using an audio cable, USB connection, or Bluetooth connection, for example.

IHS 201 has one or more input devices, such as an internal keyboard 217 or an external keyboard 218. The keyboards may be a direct or wired connection to IHS 201 or they may be wirelessly connected, such as a Bluetooth connection between keyboard 218 and IHS 201.

Keyboards have different form factors that vary in size and key type and layout, which may depend upon the type of operating system used by IHS 201 and user preferences. When a user presses a key on keyboard 218, for example, the keyboard sends an electronic signal that corresponds to the specific key. A controller inside keyboard 218 detects which key has been pressed by identifying its unique scan code (i.e., a specific number or code assigned to each key). Each key on a keyboard is associated with a specific electrical circuit. When a key is pressed, the circuit completes to generate a unique scan code representing that particular key. This scan code is transmitted to the keyboard's microcontroller. The microcontroller transmits the scan code to IHS 201 via an interface, such as a USB, Bluetooth, or PS/2 connection. For example, on a USB keyboard, the scan code is sent in packets over the USB connection. Bluetooth keyboards follow a similar process over a wireless connection.

The scan code enters the IHS's operating system through an interrupt, which is a signal to the processor to temporarily pause its current task and prioritize handling the scan code. The operating system receives the scan code and uses a keyboard driver to interpret it. The keyboard driver translates the raw scan code into a key code, which represents the actual key pressed in terms that the operating system understands. This translation considers the keyboard layout (e.g., a QWERTY layout) to match the physical key with the intended character, command, or function. Once translated, the key code is passed to an active application. For example, if a user is typing in a text editor, the key code for the “A” key is converted to the character “A” in the application. The application may interpret the input based on its own function capabilities (e.g., pressing “Ctrl+S” in many applications triggers a Save command). In some cases, the operating system may also send signals back to keyboard 218 for tasks such as lighting LEDs (e.g., on a selected Caps Lock key, Num Lock key, etc.).

When the user releases a key, the keyboard sends a separate break code to the IHS to indicate that pressure on the key has been lifted. This process lets the operating system know that the key is no longer being selected, which can stop certain actions such as repeating characters. This chain of events occurs in milliseconds, enabling real-time interaction between user keyboard and computer. The exact steps may vary depending on the type of keyboard (e.g., mechanical, membrane) and the computer's architecture.

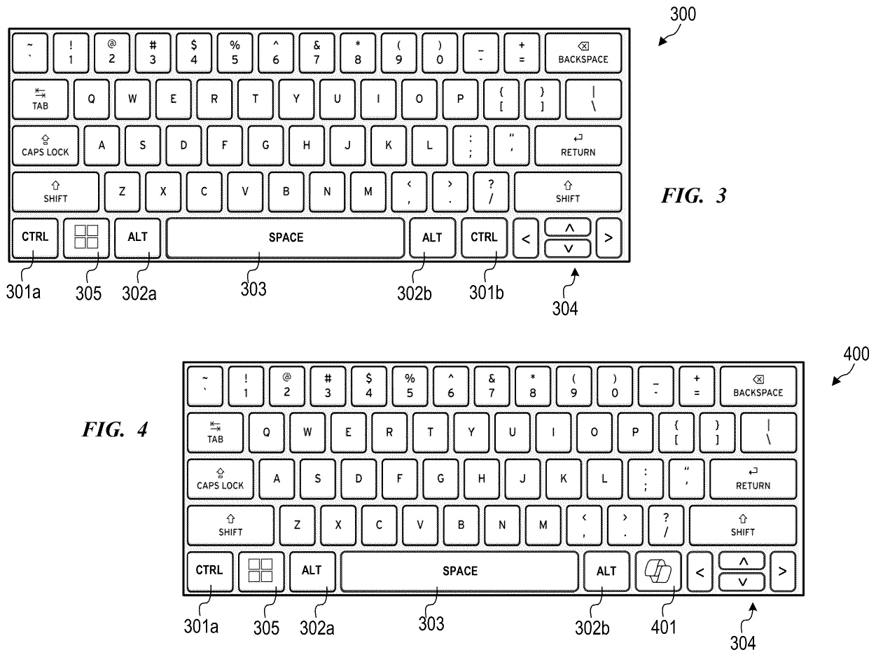

FIGS. 3-6 illustrate example keyboard variations across different operating system. Keyboard layout 300 in FIG. 3 is an example of a Windows operating system keyboard typically used with Windows version 10 and below. Keyboard layout 300 includes the alphanumeric keys and punctuation keys that are typically found in a typewriter-type layout. Additionally, the bottom row includes command keys, such as left and right control (“CTRL”) keys 301a,b and left and right Alternative (“ALT”) keys 302a,b on either side of space bar 303. Cursor keys (or “Arrow Keys”) 304 allow the user to control a cursor's movement line-by-line vertically or character-by-character horizontally. Keyboard layout 300 also has a Windows key 305, which was introduced in 1994, has the effect of opening the Start menu or may act as a modifier for system shortcuts when used with an IHS running the Windows operating system (e.g., Windows Key+ “E” will open the File Explorer).

Keyboard layout 400 in FIG. 4 is an example of a Windows operating system keyboard introduced in 2024. Layout 400 has the typical alphanumeric, punctuation, cursor control, and the bottom row command keys that are present in FIG. 3. Additionally, keyboard layout 400 adds a new Windows Copilot key 401 that is intended to provide quick access to Microsoft's AI-powered Windows Copilot experience directly from a keyboard button press. In the example layout 400, the Windows Copilot key 401 has replaced the right Control key 301b found in the older layout 300 (FIG. 3). On Windows keyboards, the left and right Control keys 301a and 301b have the same effect as each other (i.e., they are a modifier key that performs special functions when pressed simultaneously with another key). Similarly, the left and right Alternative keys 302a and 302b have the same effect as each other (i.e., a modifier key that changes the function of other keys when pressed simultaneously). Accordingly, changing the functionality of the right Control key 301b (FIG. 3) to a Windows Copilot key 401 (FIG. 4) will not result in the user losing any features.

The Copilot key 401 is a single-purpose feature key added to keyboards made for Microsoft Windows version 11. Copilot key 401 triggers the launch of an interface to a Large Language Model called Copilot. The physical key on the keyboard will typically have a Copilot logo. In one configuration, the Copilot key 401 sends data equivalent to Left Windows+Left Shift+F23, where F23 refers to function key 23. The Copilot assistant can also be launched in Windows version 11 with the key combination Windows+C, which in previous Windows versions launched the Cortana assistant.

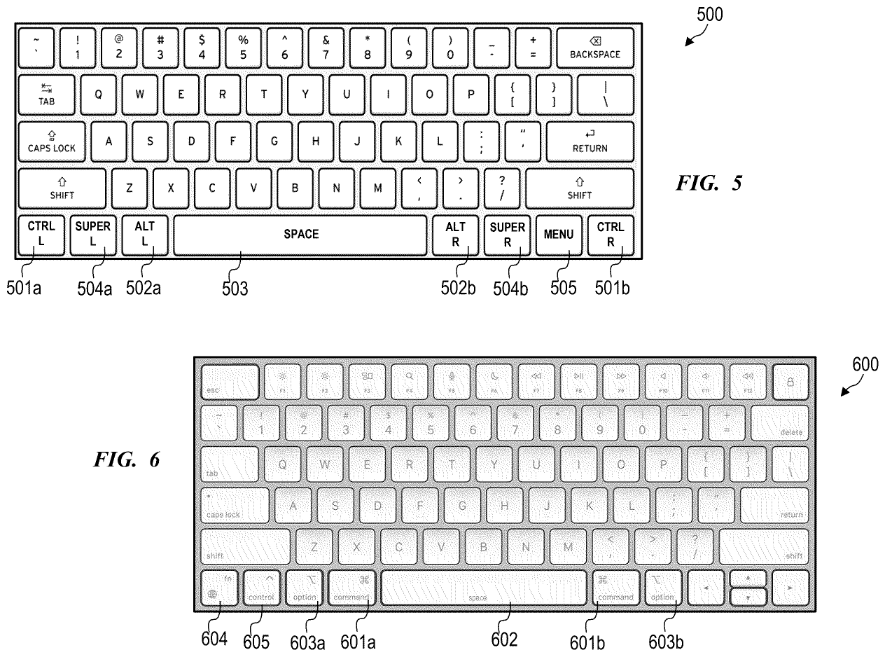

Keyboard layout 500 in FIG. 5 is an example of a Linux operating system keyboard. Linux keyboard layouts can vary widely, but many default to a keyboard layout that is similar to Windows. As shown in FIG. 5, the bottom row of keys in layout 500 includes left and right Control keys 501a,b and left and right Alternative keys 502a,b on either side of space bar 503. Linux keyboard layout 500 also includes left and right Super keys 504a,b that are often mapped to open the main menu or perform other system-specific tasks. Linux keyboard layout 500 may include a Menu key 505 with a primary function of launching a context menu.

Keyboard layout 600 in FIG. 6 is an example of an Apple Macintosh operating system (“macOS”) keyboard. Mac keyboards 600 have Command keys 601a,b on opposite sides of space bar 602 instead of the Windows key 305. The Command key 601a,b is central to accessing macOS shortcuts. The macOS keyboard layout 600 also includes an Option key 603a,b as another special key, which replaces the Alt key 302a,b in some cases. The Globe key (or Fn key) 604 in keyboard layout 600 is a modifier key for Apple devices that allows users to access functions that do not have their own physical keys. The macOS Control key 605 serves functions related to keyboard shortcuts and contextual menus.

The examples shown in FIGS. 3-6 use the standard QWERTY layout. In other configurations of the alphabet keys are also in use, such as Dvorak and Colemak layouts. For simplicity, the example layouts in FIGS. 3-6 illustrate only the typing and control keys. In other configurations, additional well-known keys may be included in the keyboard layout, such as function keys across a top row or a number pad, a separate arrow key group, or editing keys (e.g., “Insert,” “Delete,” “Home,” “End,” “Page Up,” and “Page Down” keys) to the right of the typing keys.

Generally, a computer workstation will include a keyboard configured for the operating system that is loaded on the associated IHS. Problems can arise when users change the operating system on the IHS but do not change the keyboard. As noted above, different operating systems different have keyboard requirements with specialized keys (e.g., Windows key 305, Copilot key 401, Super keys 504a,b, Menu key 505, Command keys 601a,b, and Option keys 603a,b). These specialized keys are not relevant to different operating system environments. For example, the Linux operating system has no need for the Windows key 305 or the Copilot key 401 from the Windows operating system.

When an IHS is changed from the Windows operating system to the Linux operating system, for example, there will be problems if the IHS is connected to a Copilot keyboard layout 400 and the keyboard is not changed. The Copilot keyboard layout 400 has keys (i.e., Windows key 305, Copilot key 401) for which the Linux operating system has no defined use. Moreover, the keyboard will be missing keys that the Linux operating system requires for some functionalities (e.g., Super keys 504a,b, Menu key 505, and right Control key 501b). There is a risk of lost productivity and value for the user of an operating system that does not work with the extra keyboard keys and that has a defined use for missing keys.

To address the problems of mismatched operating systems and keyboard layouts, users may want to disable or remap keys for a specific use case and have those changes remain persistent. This ability will add value to what otherwise would be an unused key on a keyboard. Also, this would allow vendors and manufacturers to fulfill contractual obligations to various vendors (e.g., meet licensing requirements to include certain keys in order to use a particular operating system) while giving customers needed functionality when another operating system is loaded on the machine. Further, this gives customers/users control over how the keyboard interface works based on their own use cases and requirements. In some cases, the IHS may support automatic changing of the keyboard layout and macros depending on specific usage, operating system environment, and/or applications.

In one embodiment, an IHS supports dynamic switching of keyboard scan codes based on a bootloader configuration. For example, the scan codes for Windows key 305 and Copilot key 401 can be changed in the EC/BIOS by the bootloader when the IHS is not using a Windows operating system. The bootloader code is enhanced to allow for setting of keycode on a per boot menu item basis. During the creation of a boot menu item, there may be default values set for all of the keys on the keyboard (e.g., defaults set by a vendor at manufacturing). The user or system administrator may edit that menu item and change the scan code mapping.

As an example, the Copilot key 401 will replace the right Control key 301b on new Windows keyboards. For operating systems that do not use the Copilot key 401, the boot menu may be configured so that the Copilot key 401 does not send its default code, but instead sends the code associated with the right Control key 301b, thereby restoring the functionality lost by the introduction of the Copilot key 401.

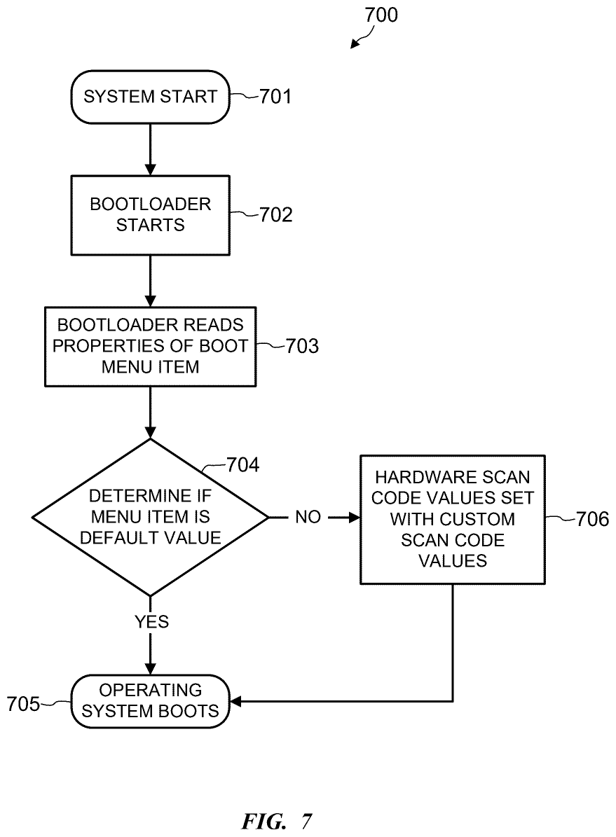

FIG. 7 is a flowchart illustrating an example process 700 for dynamic switching of keyboard scan codes based on bootloader configuration. At 701, the system starts when the IHS is turned on or restarted. At 702, the IHS bootloader starts as part of the boot process. At 703, the bootloader reads the properties of a boot menu item. The menu item has been configured by the user or by a system administrator. For example, depending on the IHS manufacturer, common keys for accessing the boot menu are Esc, F2, F10, or F12. The key press required to access the boot menu is usually specified on the IHS's startup screen. The boot menu allows users to select what device to load an operating system or application from as the computer is booting. The boot menu may be configured to accept user input to replace default scan codes for some or all of the keyboard keys, which allows the user to map or remap the keys to desired functionality.

At 704, the bootloader determines whether the scan code menu item is a default value or if a new value has been entered. If default values are identified at 704, the process moves to 705 and the operating system boots using the default scan codes for the keyboard keys.

Alternatively, if one or more menu items are no longer set to default scan code values at 704, then the process moves to 706 and hardware values are set with custom scan code values selected by the user. The process then continues to 705 and the operating system boots using alternative scan codes for the keyboard keys. This would allow, for example, scan codes to be changed for the Copilot key 401 to scan codes for a right Control key 501b so that a Windows keyboard layout 400 could more easily be used with a Linux operating system.

Current dynamic keyboards are not tied to the loaded operating system environment and do not interact with system level EC/BIOS to change functionality. The solution outlined in FIG. 7 allows for the BIOS/EC scan codes to be changed dynamically based on the context. This has the advantage of being an operating-system-agnostic solution that will increase customer satisfaction and lower the need for contacts with support services.

In another arrangement, dynamic switching of keyboard scan codes may be based on operating system context. Scan codes, such as Windows key and Copilot key scan codes, can be dynamically changed in the EC/BIOS when not using a corresponding operating system, such as Windows. An agent running in the operating system communicates with the BIOS on which the operating system is being run. When the agent reports an operating system that is not compatible with the current scan codes, the BIOS loads in new values.

For example, when the Linux operating system is loaded on the system, the agent reports this and changes scan codes for incompatible keys, such as changing the scan codes for the Window key 305 and Copilot key 401 to perform another function. Then, instead of launching the Start menu or the Copilot interface, the Window key 305 and Copilot key 401 may instead cause an action such as opening up a search window or launching a web browser.

This can be expanded to include specific use cases and applications, such as, if the system is running a kiosk type of application that does not use specific keys, then those keys can be turned off or remapped to a function that can be utilized.

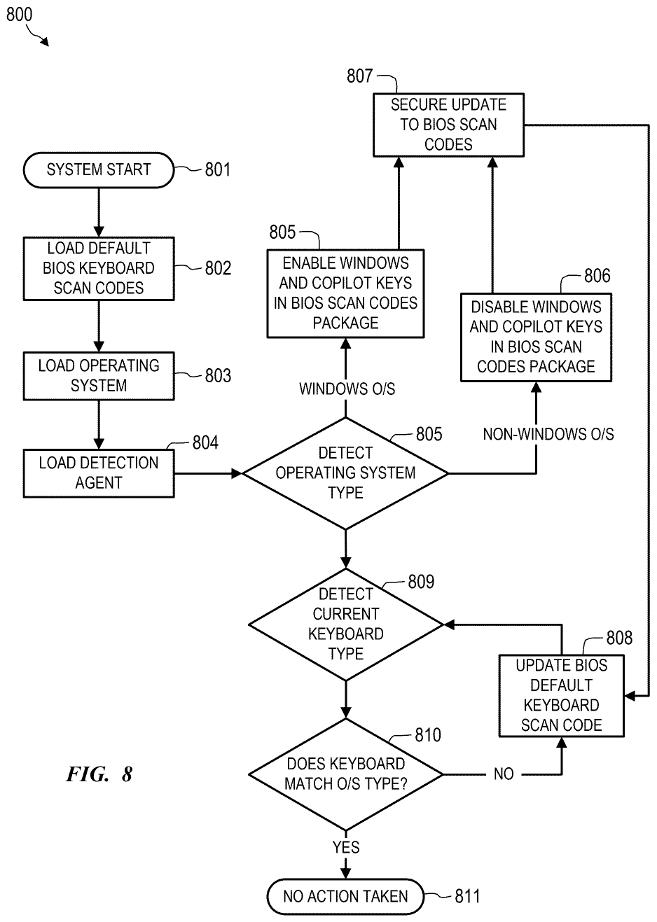

FIG. 8 is a flowchart illustrating an alternative process 800 for dynamic switching of keyboard scan codes based on operating system context. At 801, the system starts when the IHS is turned on or restarted. At 802, the default BIOS keyboard scan codes are loaded. At 803, the operating system is loaded. At 804, the detection agent is loaded. At 805, the detection agent determines what type of operating system has been loaded.

If a Windows operating system is detected at 804, then the process moves to 805 and the Windows and Copilot keys are enabled in a BIOS scan codes package. Alternatively, if a non-Windows operating system is detected at 804 (e.g., a Linux or macOS operating system is detected), then the process moves to 806 and the Windows and Copilot keys are disabled in the BIOS scan codes package.

After the appropriate enabling or disabling of the scan codes at 805 or 806, the process moves to 807 where a secure update to the BIOS scan codes is performed. At 808, the agent updates the BIOS default keyboard scan codes.

Simultaneously with, or sequentially after, the operations at 805 and 806, the process detects the current keyboard type at 809. Then, at 810, the agent determines whether the keyboard type matches the operating system type. If the keyboard type does not match the operating system type, then the process moves to 808 and the agent updates the scan code.

The process continues with the updated scan code at 808 to detect the current keyboard type at 809 again. Then, at 810, the agent again determines whether the keyboard type matches the operating system type. If the keyboard type does match the operating system type, then the process moves to 811 and no further action is taken regarding the scan codes and the IHS complete a boot process.

Current dynamic keyboards are not tied to the currently loaded operating system environment and, therefore, the keyboards do not interact with system level EC/BIOS to change functionality. This process illustrated in FIG. 8 allows for the BIOS/EC scan codes to be changed dynamically based on the operating system context. This has the advantage of being an operating-system-agnostic solution that will increase customer satisfaction and lower the need for contacts with support services.

In another configuration, keyboard scan codes may be manually switched in BIOS/EC. As disclosed herein, users may want to disable or remap keyboard keys for their specific use cases and have those changes remain persistent. This adds value to what normally would be an unused key on a keyboard and gives users control to change how the keyboard interface works based on their use cases.

Certain keyboard scan codes, such as the scan codes for the Windows key 305 and the Copilot key 401, can be dynamically changed in the EC/BIOS when the IHS is not using a compatible operating system, such as a Windows operating system where the keyboard includes the Windows key 305 and the Copilot key 401. This solution would allow a customer to change at the BIOS level what each key does and how it is mapped.

A user may interact with the BIOS/EC from a High Level Operating System (HLOS) as well as directly change the mapping of keyboard keys in the BIOS. For example, if the Linux operating system is loaded on an IHS, an agent reports this status and changes the Windows key 305 and the Copilot key 401 to open up search or to launch a web browser. Alternatively, the agent may remap the Copilot key 401 to a right Control key 501b. This would allow an example use case wherein as a user who is playing a video game can turn off the Windows key, so that pressing that key does not accidently knock the application out of focus.

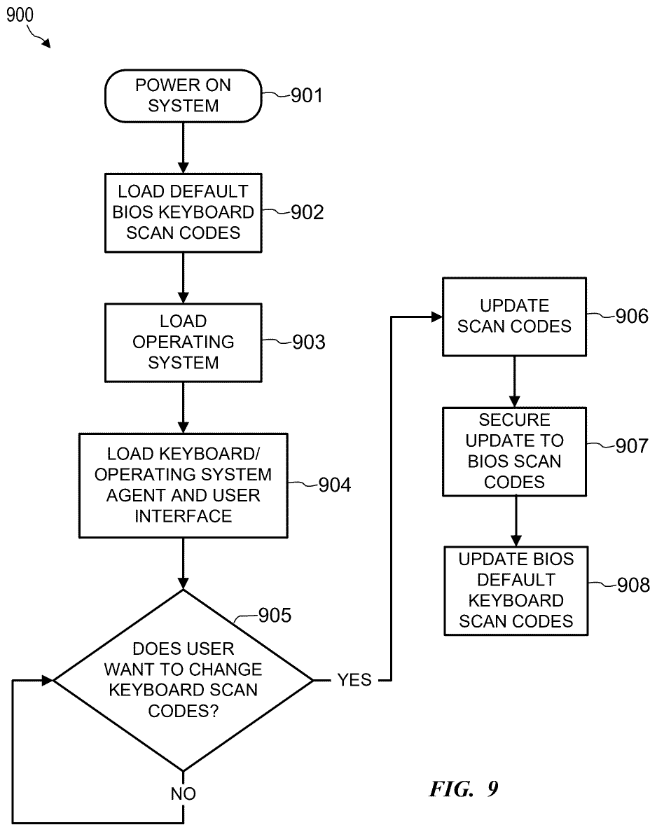

FIG. 9 is a flowchart illustrating a process 900 for manual switching of keyboard scan codes in BIOS/EC. At 901, the system is powered on. At 902, the default BIOS keyboard scan codes are loaded. At 903, the operating system is loaded. Then, at 904, a keyboard/operating system agent is loaded by the IHS along with a user interface, which would allow a user to manually select which scan codes to modify and how.

The agent waits at 905 to determine whether the user wants to change keyboard scan codes. This user's intention may be determined, for example, by selection of a user interface option to select keyboard scan codes to be remapped or disabled. Once the user indicates that certain keyboard scan codes are to be changed at 905, then the process moves to 906 where the user may update the scan codes. At 907, the agent performs a secure update to the BIOS scan codes. At 908, the agent then updates the BIOS default keyboard scan codes. Updates to the default keyboard scan codes may be held over for use during the next power on so that the selected keyboard scan codes do not have to be reentered after every start-up of the IHS.

In an example configuration, an Information Handling System (IHS), comprises at least one processor configured to execute an operating system (OS), an embedded controller (EC) configured to interface with a basic input/output system (BIOS) to manage keyboard scan codes, and a bootloader. The bootloader is configured to read properties of a boot menu item associated with keyboard scan codes, determine if the menu item is set to a default keyboard scan code value, and set hardware values with user-selected keyboard scan codes, if the menu item is not set to a default value. The operating system is configured to boot the IHS with the user-selected scan codes.

The bootloader is further configured to provide a boot menu to a user, the boot menu comprising one or more items associated with the keyboard scan codes. The bootloader is further configured to receive user-selected keyboard scan codes via he boot menu.

The user-selected keyboard scan codes are configured to remap keyboard keys.

The operating system may be a Linux operating system, and the user-selected keyboard scan codes are configured to remap a Windows Copilot key scan code to a right Control key scan code. The IHS may further comprise a keyboard, wherein a Windows Copilot key is activated on the keyboard, the operating system is configured to receive a scan code for a right Control key.

In another example configuration, a method for dynamic switching of keyboard scan codes comprises loading default basic input/output system (BIOS) keyboard scan codes on an Information Handling System (IHS), loading an operating system on the IHS, loading a detection agent on the IHS, automatically detecting, by the detection agent, a type of operating system loaded, automatically detecting, by the detection agent, a type of keyboard attached to the IHS, determining, by the detection agent, whether the keyboard type matches the operating system type, and if the keyboard type matches the operating system type, then completing an IHS boot process, or if the keyboard type does not match the operating system type, then updating a default keyboard scan code.

The updated default keyboard scan code is selected to match a key on a keyboard with the operating system.

A keyboard may be coupled to the IHS. The keyboard comprises a plurality of keys, and wherein a selected key is associated with a function that is not available on the operating system, and wherein the updated default keyboard scan code is configured to remap the selected key to a function that is available on the operating system.

The method may further comprise enabling a selected keyboard key in a BIOS scan codes package if the selected key is associated with the operating system, and disabling the selected keyboard key in the BIOS scan codes package if the selected key is not associated with the operating system. The method may further comprise updating BIOS scan codes. The method may further comprise updating BIOS default scan codes to match the operating system.

The type of keyboard detected comprises one or more keys associated with functions that are not available from the type of operating system detected; and wherein the updated default keyboard scan code is configured to remap the one or more keys to functions that are available from the type of operating system detected. The one or more keys may be selected from the group consisting of: a Windows key, a Copilot key, a Super key, a Menu key, a Command key, and an Option key. The one or more keys may be selected from the group consisting of a Windows key and a Copilot key, wherein the type of operating system is detected to be a Linux operating system; and wherein the updated default keyboard scan code is configured to remap the Windows key to a function available on the Linux operating system and to remap the Copilot key to a right Control key.

In another configuration, a method for manual switching of keyboard scan codes comprises loading default BIOS keyboard scan codes on an Information Handling System (IHS), loading an operating system on the IHS, loading a keyboard agent on the IHS, providing a user interface to allow a user to select default BIOS keyboard scan codes to modify, and updating the default BIOS keyboard scan codes based on a user input.

The method may further comprise performing a secure update to the BIOS scan codes. The updating of the BIOS default keyboard scan codes is configured to ensure persistence of a user-selected BIOS keyboard scan codes across system restarts. The user interface may provide options to disable specific keys that are not required by the operating system. The secure update to the BIOS scan codes includes verifying the integrity of the update process to prevent unauthorized modifications.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. An Information Handling System (IHS), comprising:
at least one processor configured to execute an operating system (OS);
an embedded controller (EC) configured to interface with a basic input/output system (BIOS) to manage keyboard scan codes; and
a bootloader configured to:
read properties of a boot menu item associated with keyboard scan codes;
determine if the menu item is set to a default keyboard scan code value; and
set hardware values with user-selected keyboard scan codes, if the menu item is not set to a default value; and
wherein the operating system is configured to boot the IHS with the user-selected scan codes.

2. The IHS of claim 1, wherein the bootloader is further configured to provide a boot menu to a user, the boot menu comprising one or more items associated with the keyboard scan codes.

3. The IHS of claim 2, wherein the bootloader is further configured to receive user-selected keyboard scan codes via the boot menu.

4. The IHS of claim 1, wherein the user-selected keyboard scan codes are configured to remap keyboard keys.

5. The IHS of claim 1, wherein the operating system is a Linux operating system, and the user-selected keyboard scan codes are configured to remap a Windows Copilot key scan code to a right Control key scan code.

6. The IHS of claim 5, further comprising:
a keyboard, wherein a Windows Copilot key is activated on the keyboard, the operating system is configured to receive a scan code for a right Control key.

7. A method for dynamic switching of keyboard scan codes, comprising:
loading default basic input/output system (BIOS) keyboard scan codes on an Information Handling System (IHS);
loading an operating system on the IHS;
loading a detection agent on the IHS;
automatically detecting, by the detection agent, a type of operating system loaded;
automatically detecting, by the detection agent, a type of keyboard attached to the IHS;
determining, by the detection agent, whether the keyboard type matches the operating system type; and
if the keyboard type matches the operating system type, then completing an IHS boot process; or
if the keyboard type does not match the operating system type, then updating a default keyboard scan code.

8. The method of claim 7, wherein the updated default keyboard scan code is selected to match a key on a keyboard with the operating system.

9. The method of claim 7, wherein a keyboard is coupled to the IHS, the keyboard comprising a plurality of keys, and wherein a selected key is associated with a function that is not available on the operating system, and wherein the updated default keyboard scan code is configured to remap the selected key to a function that is available on the operating system.

10. The method of claim 7, further comprising:
enabling a selected keyboard key in a BIOS scan codes package if the selected key is associated with the operating system; and
disabling the selected keyboard key in the BIOS scan codes package if the selected key is not associated with the operating system.

11. The method of claim 10, further comprising:
updating BIOS scan codes.

12. The method of claim 11, further comprising:
updating BIOS default scan codes to match the operating system.

13. The method of claim 7, wherein the type of keyboard detected comprises one or more keys associated with functions that are not available from the type of operating system detected; and wherein the updated default keyboard scan code is configured to remap the one or more keys to functions that are available from the type of operating system detected.

14. The method of claim 13, wherein the one or more keys are selected from the group consisting of: a Windows key, a Copilot key, a Super key, a Menu key, a Command key, and an Option key.

15. The method of claim 13, wherein the one or more keys are selected from the group consisting of a Windows key and a Copilot key;
wherein the type of operating system is detected to be a Linux operating system; and
wherein the updated default keyboard scan code is configured to remap the Windows key to a function available on the Linux operating system and to remap the Copilot key to a right Control key.

16. A method for manual switching of keyboard scan codes, comprising:
loading default BIOS keyboard scan codes on an Information Handling System (IHS);
loading an operating system on the IHS;
loading a keyboard agent on the IHS;
providing a user interface to allow a user to select default BIOS keyboard scan codes to modify; and
updating the default BIOS keyboard scan codes based on a user input.

17. The method of claim 16, further comprising:
performing a secure update to the BIOS scan codes.

18. The method of claim 16, wherein the updating the BIOS default keyboard scan codes is configured to ensure persistence of a user-selected BIOS keyboard scan codes across system restarts.

19. The method of claim 16, wherein the user interface provides options to disable specific keys that are not required by the operating system.

20. The method of claim 16, wherein the secure update to the BIOS scan codes includes verifying the integrity of the update process to prevent unauthorized modifications.
